(19) United States
(12) Patent Application Publication
(10) Pub. No.: US 2014/0091719 A1
(43) Pub. Date: Apr. 3, 2014

(54) CHRISTMAS STRING LIGHT CONTROL SYSTEM AND STRING LIGHT DEVICE THEREOF

(71) Applicant: GEORGE TSAI, Taipei (TW)

(72) Inventor: GEORGE TSAI, Taipei (TW)

(21) Appl. No.: 13/644,084

(22) Filed: Oct. 3, 2012

(51) Int. Cl. H05B 37/02

(52) U.S. Cl. 315/185 S

(57) ABSTRACT

A string light device employs a mobile device to control a string light thereof through a bluetooth connection module thereof. The mobile device is activated to switch to one of the display modes of the string light so as to operate the string light to exhibit a visual effect, such as blinking the string light according to rhythms of music or sounds or changing the luminance or color or the string light. Accordingly, users achieve to wirelessly control a string light by simply using a mobile device, such as a smart phone or a tablet personal computer.

### BACKGROUND OF THE INVENTION

1. Field of the Invention

The present invention relates to a Christmas string light control system and a string light device thereof and more particularly to a Christmas string light control system and a string light device thereof capable of being controlled by a smart phone or a tablet personal computer (PC).

2. Description of the Related Art

People usually string Christmas lights on Christmas trees as an ornament to celebrate Christmas and weave the Christmas lights through the Christmas trees to create festive atmosphere. Christmas string lights in early days have no particular design but are simply lit up to decorate the Christmas trees.

To keep abreast with technical advancement, latest Christmas lights have been designed to turn on according to various display modes. With reference to FIG. 7, a conventional string light device has a string light 60, a control module 70 and a power input module 80. The control module 70 serves to control the string light 60 according to one of multiple display modes. The power input module 80 serves to acquire a mains power and outputs an operating power. The control module 70 is electrically connected to the string light 60, and memorizes the display modes of the string light 60. The selected display mode is activated to alternately light up the light bulbs on the string light 60, display a different lighting pattern to suit the alignment of the string light 60, regularly change luminance of the string light 60, or demonstrate any visual effect that the string light is capable of displaying. The string light device then provides a visual effect based on the selected display mode when the control module 70 controls the string light 60 to operate according to the selected display mode. The power input module 80 is electrically connected to the control module 70 and the string light 60 to provide the operating power to the control module 70 and the string light 60.

If the control module memorizes multiple display modes, the conventional string light device must have a switch mounted on the control module for users to switch among the display modes. Thus, users must approach the string light device and then switch to a desired display mode. Such restriction certainly causes operational inconvenience in using the conventional string light device.

### SUMMARY OF THE INVENTION

An objective of the present invention is to provide a Christmas string light control system and a string light device thereof allowing users to wirelessly control a string light thereof and exhibit a desired visual effect through the use of a mobile device.

To achieve the foregoing objective, the Christmas string light control system has a string light, a control end device and a mobile device.

The control end device is electrically connected to the string light and has a bluetooth connection module.

The mobile device is wirelessly connected to the bluetooth connection module of the control end device, and transmits a wireless signal to the control end device for the control end device to control the string light according to a selected display mode.

To achieve the foregoing objective, the string light device has a string light, a bluetooth connection module and a control module.

The bluetooth connection module is adapted to wirelessly connect to a mobile device and receive a wireless command signal transmitted from the mobile device.

The control module is electrically connected to the bluetooth connection module and the string light, and serves to control the string light according to a selected display mode. When receiving the wireless command signal transmitted from the mobile device, the bluetooth connection module converts the wireless command signal into the string light control command and transmits the string light control command to the control module. The control module then controls the string light according to the display mode mapped to by the string light control command.

The power input module serves to acquire a mains power, convert the mains power into an operating power and output the operating power, and is electrically connected to and supplies the operating power to the control module, the bluetooth connection module and the string light.

According to the foregoing technical measure, the string light device can be wirelessly connected to a currently popular mobile device, such as a smart phone or a tablet PC, through the bluetooth protocol, and the mobile device can be treated as a remote control to the string light device. Therefore, users can easily operate the string light device with their own mobile devices to perform different functions, such as blinking the string light according to rhythm of music or sounds, or changing the luminance or color of the string light.

Other objectives, advantages and novel features of the invention will become more apparent from the following detailed description when taken in conjunction with the accompanying drawings.

### BRIEF DESCRIPTION OF THE DRAWINGS

FIG. 1 is a schematic view of a Christmas string light control system in accordance with the present invention;

FIG. 2 is a perspective view of a first embodiment of a string light device of the Christmas string light control system in FIG. 1;

FIG. 3 is a perspective view of a second embodiment of a string light device of the Christmas string light control system in FIG. 1;

FIG. 4 is a functional block diagram of the Christmas string light control system in FIG. 1;

FIG. 5 is a functional block diagram of the string light device in FIG. 2;

FIG. 6 is a functional block diagram of the string light device in FIG. 3; and

FIG. 7 is a functional block diagram of a conventional string light device.

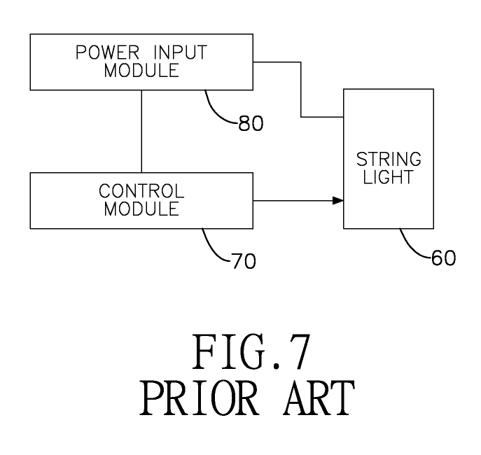

### DETAILED DESCRIPTION OF THE INVENTION

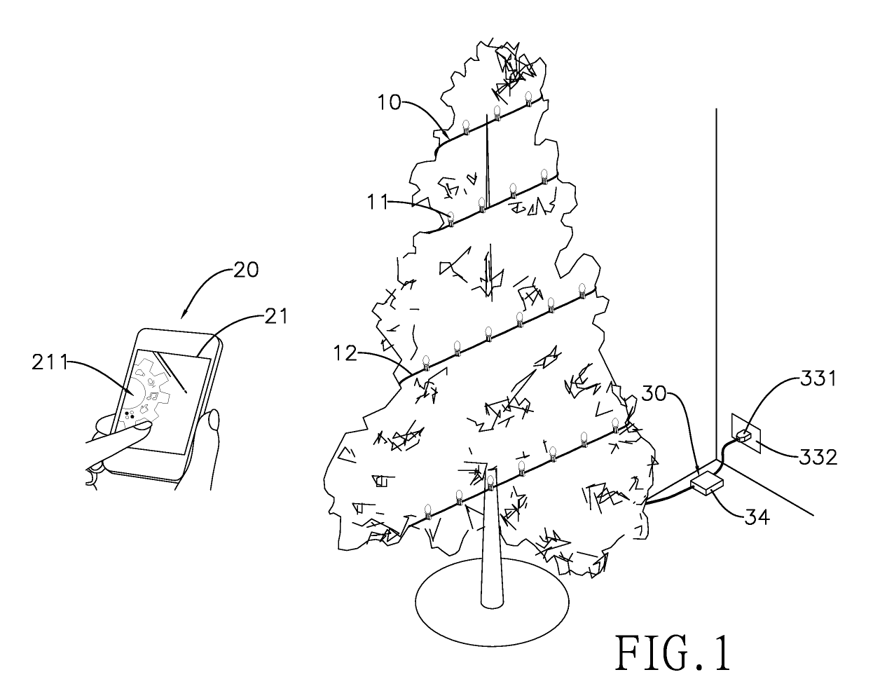

With reference to FIG. 1, a Christmas string light control system in accordance with the present invention has a string light 10, a mobile device 20, and a control end device 30. The control end device 30 is electrically connected to the string light 10 and may have a bluetooth connection module. The mobile device 20 may be a smart phone or a tablet PC. In the present embodiment, the mobile device 20 is a smart phone. The mobile device 20 is wirelessly connected to the bluetooth connection module of the control end device 30, and transmits a wireless signal to the control end device 30 so that the control end device 30 can control the string light 10 according to a selected display mode to exhibit a different visual effect.

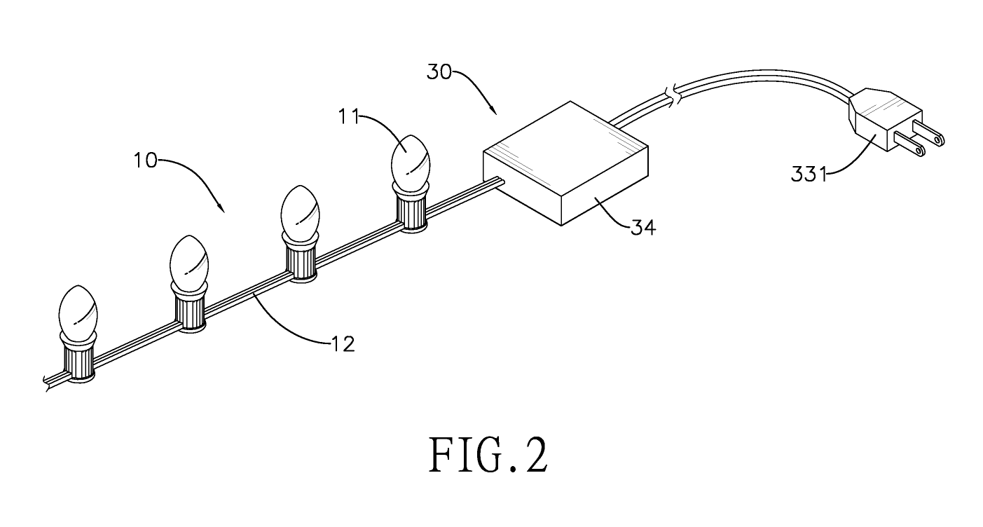

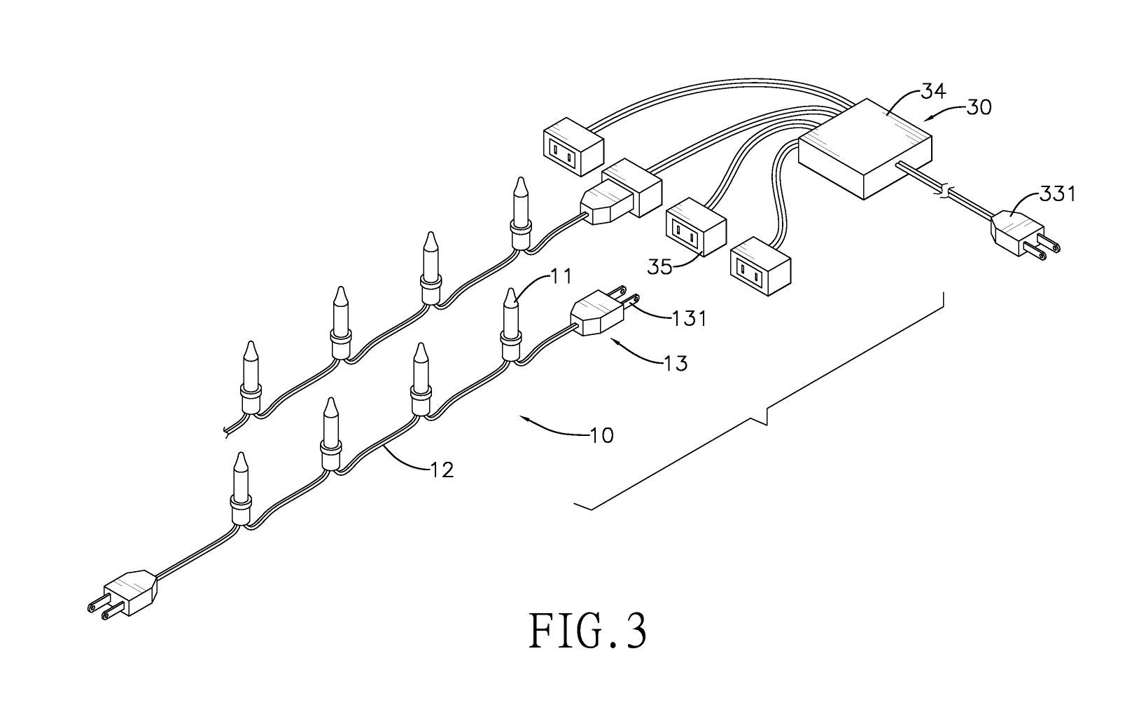

With reference to FIGS. 2 and 3, a first embodiment and a second embodiment of a string light device of the Christmas string light control system in FIG. 1 are shown. The second embodiment of the string light device differs from the first embodiment in that the second embodiment has multiple control end devices 30 and multiple string lights 10 and the control end devices 30 are detachably connected with the respective string lights 10 for users to expand the string lights 10 according to a display demand.

From the foregoing, the major design concept of the Christmas string light control system of the present invention focuses on controlling the string light 10 to generate different visual effects through operation of a smart phone or a tablet PC. As the smart phone or the tablet PC functions as a remote control dedicated to control the string light 10, it is unnecessary for manufacturers of the Christmas string light control system to manufacture dedicated remote control for controlling the string light 10 and for users to get dedicated remote control for controlling the string light 10. To control the string light 10, the users only need to directly operate a smart phone or a tablet PC.

The second embodiment of the string light device further discloses that the control end devices 30 are detachably connected with the string lights 10 and the control end devices 30 can acquire the mains power from a common power plug 331 so that users can additionally mount or dismount the string lights 10 to reflect the need of expanding the string lights 10.

With further reference to FIG. 1, the Christmas string light control system has a string light 10, a mobile device 20 and a control end device 30.

The string light 10 has multiple light bulbs 11 and an electric cable 12 connected with the light bulbs 11. In the present embodiment, the string light 10 is mounted on a Christmas tree. However, the string light 10 includes but is not limited to the string light 10 of the present embodiment. The string lights that are used to embellish or decorate things to create festive atmosphere can be all considered as the string lights of the present invention.

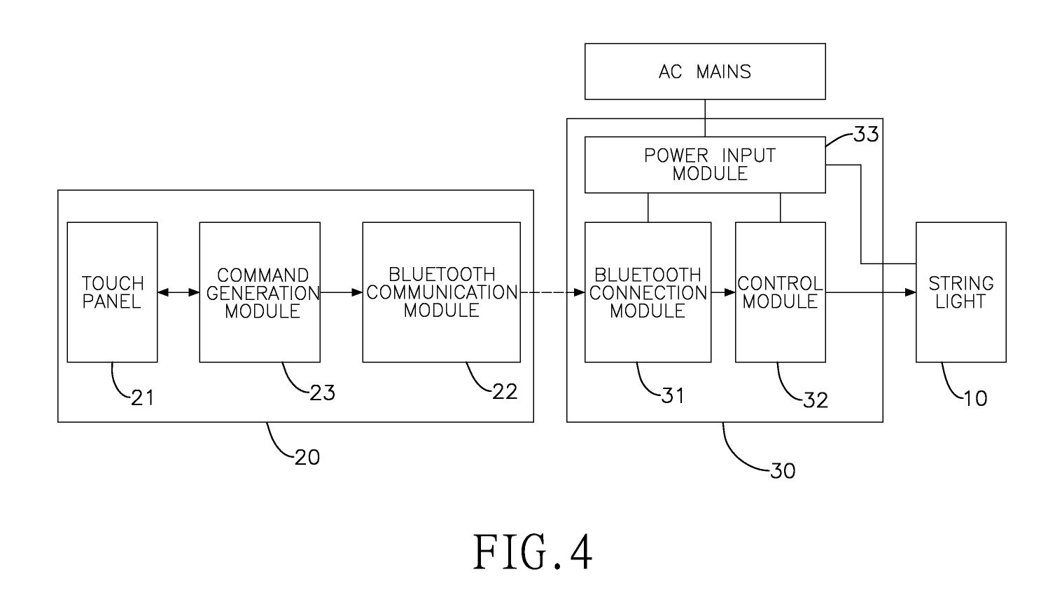

The mobile device 20 may be a smart phone or a tablet PC. In the present embodiment, the mobile device is a smart phone. With reference to FIG. 4, the mobile device 20 has a touch panel 21, a bluetooth communication module 22 and a command generation module 23.

The touch panel 21 serves to display a frame and outputs an operation command according to a user's touch event.

The bluetooth communication module 22 serves to transmit and receive wireless signals. In the present embodiment, the bluetooth communication module 22 may be a bluetooth communication module transmitting and receiving bluetooth signals or a Wi-Fi network module transmitting and receiving Wi-Fi signals.

The command generation module 23 is electrically connected to the touch panel 21 and the bluetooth communication module 22, controls the touch panel 21 to display a command input interface 211 for users to input, generates a string light control command according to the input conducted on the command input interface 211, and transmits the string light control command to the bluetooth communication module 22. The bluetooth communication module 22 converts the string light control command into a wireless command signal and transmits the wireless command signal. The command input interface 211 displayed on the touch panel 21 displays multiple functions for users to select to adjust the string light 10, such as on and off states of the string light, an overall luminance, a blinking effect varying with music stored in the mobile device 20 or with a sound received by a microphone built in the mobile device 20 and the like according to the selected display mode of the string light 10. When users select one of the functions, the command generation module 23 transmits a string light control command to the bluetooth communication module 22 according to the function selected by users.

The control end device 30 has a bluetooth connection module 31, a control module 32 and a power input module 33.

The bluetooth connection module 31 serves to wirelessly connect to the bluetooth communication module 22 of the mobile device 20 and pair with the bluetooth communication module 22 of the mobile device 20. The bluetooth connection module 31 may be a bluetooth communication module for transmitting and receiving bluetooth signals or a Wi-Fi network module transmitting and receiving Wi-Fi signals.

The control module 32 is electrically connected to the bluetooth connection module 31 and the string light 10, and serves to control the string light 10 according to the selected display mode. When receiving the wireless command signal transmitted from the bluetooth communication module 22 of the mobile device 20, the bluetooth connection module 31 converts the wireless command signal into the string light control command and transmits the string light control command to the control module 32. The control module 32 then controls the string light 10 according to the selected display mode mapped to by the string light control command.

The power input module 33 serves to acquire the mains power, converts the mains power into an operating power, and outputs the operating power. The power input module 33 is electrically connected to and supplies the operating power to the control module 32, the bluetooth connection module 31 and the string light 10.

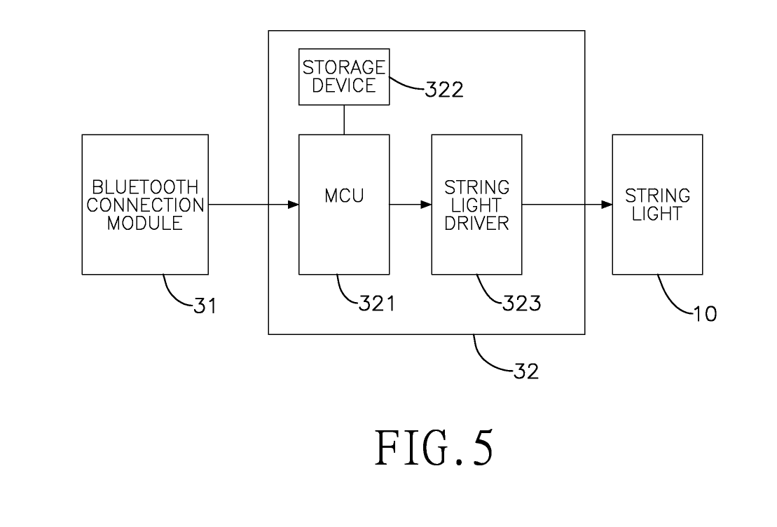

With reference to FIGS. 1, 2 and 5, the first embodiment of the string light device is a combination of the control end device 30 and the string light 10. In the present embodiment, the bluetooth connection module 31, the control module 32 and the power input module 33 are mounted inside a housing 34. The power input module 33 acquires the mains power through a plug 331 plugged in a receptacle 332 on the wall.

The control module 32 has a micro-controller unit (MCU) 321, a storage device 322 and a string light driver 323.

The MCU 321 is electronically connected to the bluetooth connection module 31 to receive the string light control command transmitted from the bluetooth connection module 31.

The storage device 322 is electronically connected to the MCU 321 and memorizes multiple display modes of the string light 10. The display modes include but are not limited to the following functions. For example, the light bulbs 11 on the string light 10 are alternately lit, are lit to demonstrate a lighting pattern according to an alignment of the light bulbs 11, are lit with the regularly varying overall luminance of the light bulbs 11, or are lit to show any other visual effect that the string light is capable of displaying.

The string light driver 323 is electronically connected to the MCU 321 and each light bulb 11 of the string light 10, controls each light bulb 11 to turn on or turn off, and adjusts the luminance of each light bulb 11.

The MCU 321 receives the string light control command from the bluetooth connection module 31, identifies a corresponding display mode in the storage device 322 according to the string light control command, and controls the string light driver 323 so that the string light 10 can be operated according to the selected display mode and demonstrate a different visual effect.

Although the first embodiment of the string light device only discloses one string light 10, persons with ordinary skill in the related art should be aware of that the plug 331 can be simultaneously connected to multiple string lights 10 and such embodiment also falls within the protection scope of the present invention.

The second embodiment of the string light device is substantially the same as the first embodiment except that the string light 10 of the second embodiment has a string light connector formed on one end of the string light 10, and the control end device 30 further has at least one control end connector electrically connected to the string light connector of the string light 10. The at least one control end connector is electrically connected to the control module 32 and the power input module 33 of the control end device 30. After the string light connector of the string light 10 is electrically connected to the at least one control end connector of the control end device 30, the control module 32 of the control end device 30 then controls the string light 10, and the power input module 33 of the control end device 30 provides an operating power to the string light 10.

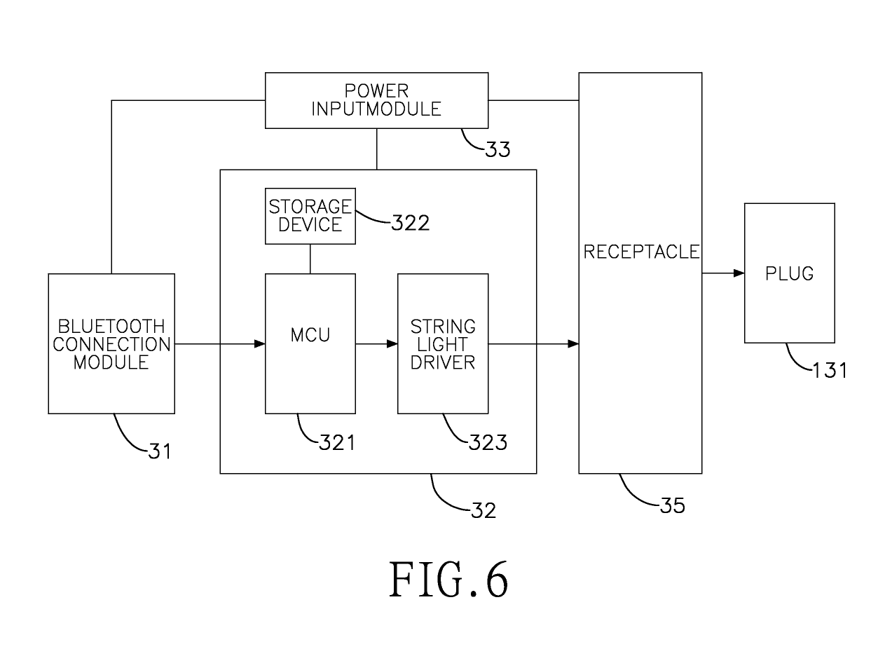

As mentioned, the string light device of the present invention may have multiple string lights 10. With reference to FIGS. 3 and 6, in the second embodiment of the string light device of the present invention, the control end device 30 has multiple control end connectors electrically connected to the respective string lights 10.

The power input module 33 of the control end device 30 remains to acquire the mains power from a plug 331.

In the present embodiment, the string light connector is a plug 13, the control end connector of the control end device 30 is a receptacle 35, and the receptacle 35 is electrically connected with the plug 13 of the string light 10.

The bluetooth connection module 31, the control module 32 and the power input module 33 are mounted inside a housing 34. When the plug 13 of the string light 10 is plugged in the receptacle 35 of the control end device 30, the string light 10 is electrically connected to the control module 32 and the power input module 33 of the control end device 30.

The control module 32 of the second embodiment is substantially the same as that of the first embodiment and has an MCU 321, a storage device 322 and a string light driver 323. When being electrically connected to the control module 32, the receptacle 35 is also connected to the string light driver 323 of the control module 32. Hence, when the plug 13 of the string light 10 is plugged in the receptacle 35 of the control end device 30, the string light 10 is electrically connected to the string light driver 323 of the control module 32 of the control end device 30.

Although FIG. 1 does not disclose the second embodiment of the string light device, those with ordinary skill in the related art should be able to understand that the second embodiment of the string light device can be implemented in FIG. 1 as well.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A Christmas string light control system comprising:
a string light;
a control end device electrically connected to the string light and having a bluetooth connection module; and
a mobile device wirelessly connected to the bluetooth connection module of the control end device, and transmitting a wireless signal to the control end device for the control end device to control the string light according to a selected display mode.

2. The Christmas string light control system as claimed in claim 1, wherein
the mobile device has:
a touch panel serving to output an operation command according to a touch event;
a bluetooth communication module serving to transmit and receive wireless signals; and
a command generation module electrically connected to the touch panel and the bluetooth communication module, controlling the touch panel to display a command input interface for a user's input, generating a string light control command according to the user's input conducted on the command input interface, and transmitting the string light control command to the bluetooth communication module for the bluetooth communication module to convert the string light control command into a wireless command signal and transmit the wireless command signal;
the control end device further has:
a control module controlling the string light according to a selected display mode; and
a power input module acquiring a mains power and outputting an operating power;
wherein the bluetooth connection serves to wirelessly connect with the bluetooth communication module, the control module is electrically connected to the bluetooth connection module and the string light, when receiving the wireless command signal transmitted from the bluetooth communication module of the mobile device, the bluetooth connection module converts the wireless command signal into the string light control command and transmits the string light control command to the control module, the control module then controls the string light according to the selected display mode mapped to by the string light control command, and the power input module is connected to and supplies the operating power to the control module, the bluetooth connection module and the string light.

3. The Christmas string light control system as claimed in claim 2, wherein the control module has:
a micro-controller unit (MCU) electronically connected to the bluetooth connection module to receive the string light control command transmitted from the bluetooth connection module;
a storage device electronically connected to the MCU and memorizing multiple display modes of the string light;
a string light driver electronically connected to the MCU and the string light, wherein when receiving the string light control command from the bluetooth connection module, the MCU identifies a corresponding display mode in the storage device according to the string light control command, and controls the string light driver so that the string light is operated according to the identified display mode.

4. The Christmas string light control system as claimed in claim 3, wherein
the string light has a string light connector formed on one end of the string light; and
the control end device further has a control end connector electrically connected to the string light connector of the string light, the control module and the power input module of the control end device.

5. The Christmas string light control system as claimed in claim 4, wherein
the string light connector is a plug;
the bluetooth connection module, the control module and the power input module are mounted inside a housing; and
the control end connector of the control end device is a receptacle electrically connected with the plug of the string light.

6. A string light device comprising:
a string light;
a bluetooth connection module adapted to wirelessly connect to a mobile device and receive a wireless command signal transmitted from the mobile device;
a control module electrically connected to the bluetooth connection module and the string light and serving to control the string light according to a selected display mode, wherein when receiving the wireless command signal transmitted from the mobile device, the bluetooth connection module converts the wireless command signal into the string light control command and transmits the string light control command to the control module, and the control module then controls the string light according to the display mode mapped to by the string light control command; and
a power input module serving to acquire a mains power, convert the mains power into an operating power and output the operating power, and electrically connected to and supplying the operating power to the control module, the bluetooth connection module and the string light.

7. The string light device as claimed in claim 6, further comprising a control end connector, wherein
the control end connector is electrically connected to the control module and the power input module; and
the string light has a string light connector formed on one end of the string light and electrically connected with the control end connector.

8. The string light device as claimed in claim 6, wherein the control module has:
an MCU electronically connected to the bluetooth connection module to receive the string light control command transmitted from the bluetooth connection module;
a storage device electronically connected to the MCU and memorizing multiple display modes of the string light; and
a string light driver electronically connected to the MCU and the string light, wherein when receiving the string light control command from the bluetooth connection module, the MCU identifies a corresponding display mode in the storage device according to the string light control command, and controls the string light driver so that the string light is operated according to the identified display mode.

9. The string light device as claimed in claim 7, wherein the control module has:
an MCU electronically connected to the bluetooth connection module to receive the string light control command transmitted from the bluetooth connection module;
a storage device electronically connected to the MCU and memorizing multiple display modes of the string light; and
a string light driver electronically connected to the MCU and connected to the string light through the control end connector and the string light connector, wherein when receiving the string light control command from the bluetooth connection module, the MCU identifies a corresponding display mode in the storage device according to the string light control command, and controls the string light driver so that the string light is operated according to the identified display mode.

10. The string light device as claimed in claim 7, wherein
the string light connector is a plug;
the bluetooth connection module, the control module and the power input module are mounted inside a housing; and
the control end connector is a receptacle electrically connected with the plug of the string light.

11. The string light device as claimed in claim 8, wherein
the string light connector is a plug;
the bluetooth connection module, the control module and the power input module are mounted inside a housing; and
the control end connector is a receptacle electrically connected with the plug of the string light.

12. The string light device as claimed in claim 9, wherein
the string light connector is a plug;
the bluetooth connection module, the control module and the power input module are mounted inside a housing; and
the control end connector is a receptacle electrically connected with the plug of the string light.
